(19) United States
(12) Patent Application Publication
(10) Pub. No.: US 2016/0105703 A1
(43) Pub. Date: Apr. 14, 2016

(54) Systems and Methods of Discovering Illegal Service Appropriation

(71) Applicant: COX COMMUNICATIONS, INC., Atlanta, GA (US)

(72) Inventor: Kinney Chapman Bacon, Lawrenceville, GA (US)

(73) Assignee: COX COMMUNICATIONS, INC., Atlanta, GA (US)

(21) Appl. No.: 14/509,194

(22) Filed: Oct. 8, 2014

(51) Int. Cl. H04N 21/258; H04N 21/24

(52) U.S. Cl. CPC H04N 21/25816; H04N 21/24

(57) ABSTRACT

A ranging function provides the location of a set top box (STB) in a telecommunications system. The distance in time from a cable modem termination system (CMTS) to the STB is a fixed time. This time determines a ranging value. To determine the ranging value, a ranging signal is sent from the CMTS to the STB. The STB, immediately upon receiving the ranging signal, transmits a return signal, which is received by the CMTS. The CMTS measures this time, and determines the ranging value. An account may be validated by comparing the ranging value to an expected value.

### TECHNICAL FIELD

The present disclosure is generally related to telecommunications and, more particularly, is related to subscriber cable systems.

### BACKGROUND

If a person in one residence connects to the cable service from a second residence, saving the cost of a monthly television bill, constitutes theft. Even if a person has just moved into a home to discover that the last resident never turned off the cable service, continued use of the service constitutes theft. Cable companies listen to tips from the public and periodically run system audits to detect unauthorized users.

Criminal penalties for cable television theft generally depend on the value of the services taken. If the person has been watching free cable for a month, the penalty won't be as serious as if you've been doing it for six months—the value of what has been stolen increases with the number of monthly bills for services not paid. In some states, if a value of $500 or more of unauthorized services is stolen, the offense is considered a felony; otherwise, the theft may be a misdemeanor.

The cable company can also sue the offender in civil court to try to recover the money that should have paid for services but was not. The offender may also be held liable for punitive damages. Moreover, the offender may be ordered to pay the company's legal costs and attorney fees as well.

Internet speeds may be affected when theft of broadband services occurs or if an individual makes an unauthorized connection to a cable line The theft may affect authorized subscriber cable bills because poor system performance may lead to increased maintenance service calls. Additionally, signal leakage due to theft may affect aviation radio equipment as well as emergency service radio communications.

Active cable theft occurs when someone takes active steps to receive services offered over a cable system without the authorization of the cable company. Passive theft occurs when someone moves into a new residence or business facility and notices that the premises receives cable services without an account but nevertheless does not take any steps to become a subscriber or have the service disconnected.

It is illegal not only to steal cable services but also to assist others in stealing cable services. Federal law provides for criminal penalties and civil remedies against people who willfully assist others in stealing cable services. Such assistance can take the form of distributing “pirate” cable television descrambling equipment, assisting others to make unauthorized connections to cable systems, promoting the free use of one's wireless broadband network, or assisting others to hack into their modems and uncap them. Federal statutes prohibit the assistance of theft of services offered over a cable system.

Primary theft of cable services involves instances in which someone does not subscribe to any cable services but makes (and/or maintains) an unauthorized connection to a cable company's cable system. This type of theft can occur when someone takes affirmative steps to connect his or her residence or business to the system or has someone make the connection for them.

A trained cable installer from the cable company checks at the outside box, where it enters a home or apartment building. The installer opens the dome, panel, or box and visually checks if the coaxial cable that feeds internet/television signals into the residence is physically connected to the house, and if so, if the resident is a paying subscriber. Even though the cable may be connected to the residence, there might be a filter or blocker inline with the cable, either for filtering out TV if the subscriber only pays for Internet or blocking the signal completely. Special equipment or signals may also be used to determine if someone is attempting to circumvent the filter. However these methods of discovering illegal service appropriation are hit and miss and there are heretofore unaddressed needs with previous solutions.

### SUMMARY

Example embodiments of the present disclosure provide systems of discovering illegal service appropriation. Briefly described, in architecture, one example embodiment of the system, among others, can be implemented as follows: a transmitter configured to transmit a ranging signal to a customer premises equipment (CPE); a receiver configured to receive a return signal from the CPE; a timer configured to measure the time between the transmit by the transmitter and the receive by the receiver; and a processor configured to save a ranging value based on the time and to validate an account by comparing the ranging value to an expected value.

Embodiments of the present disclosure can also be viewed as providing methods for discovering illegal service appropriation. In this regard, one embodiment of such a method, among others, can be broadly summarized by the following steps: sending a ranging signal to a customer premises equipment (CPE); receiving a return signal from the CPE; measuring the time from the sending to the receiving; saving a ranging value based on the time; and validating an account by comparing the ranging value to an expected value.

### BRIEF DESCRIPTION OF THE DRAWINGS

FIG. 1 is a system block diagram of an example embodiment of a cable distribution system.

FIG. 2 is a system block diagram of an example embodiment of a distribution network from a node to a plurality of homes.

FIG. 3 is a system block diagram of a CMTS of the cable distribution system of FIG. 1.

FIG. 4 is a system block diagram of an example embodiment of a billing system of the cable distribution system of FIG. 1.

FIG. 5 is a flow diagram of an example embodiment of a method of discovering illegal services appropriation.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Data Over Cable Service Interface Specifications (DOCSIS) is a standard interface for cable modems that handle incoming and outgoing data signals between a cable television operator and a personal or business computer or television set. DOCSIS may be utilized to perform 2-way communication with residence set top boxes (STBs). Downstream transmission involves one transmitter transmitting to many receivers (for example, from headend to subscriber homes). Upstream transmission involves many transmitters transmitting to one receiver (for example, from the subscriber home to the headend). A Cable Modem Termination System (CMTS) comprises the transmitter and receiver for DOCSIS.

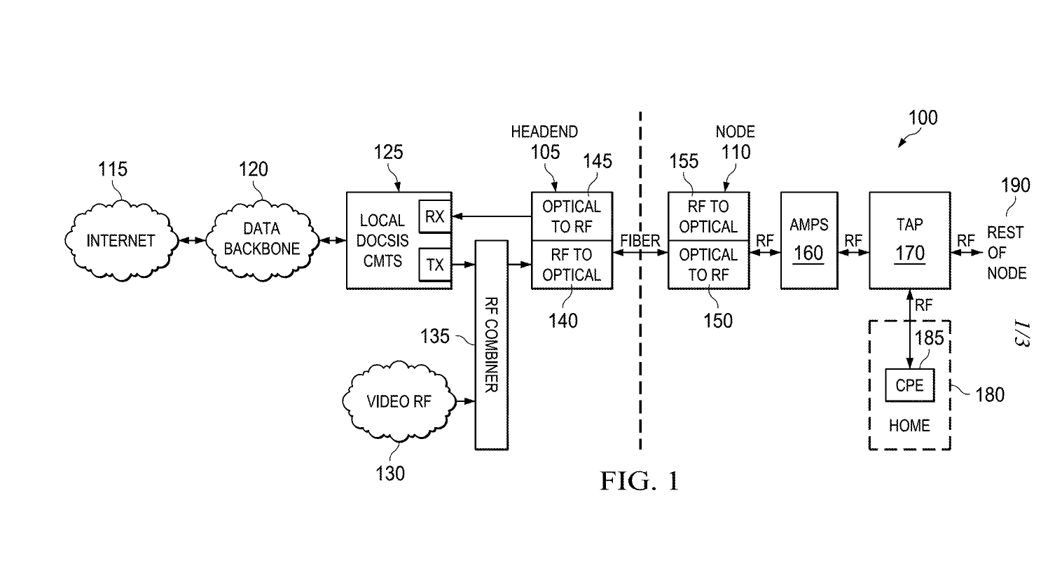

FIG. 1 provides a system block diagram of an example embodiment of cable modem system 100 using the DOCSIS standard. Although the example embodiments are provided in relation to the DOCSIS standard, the disclosed systems and methods of discovering illegal services appropriation may be applied to other cable systems as well as satellite and other service delivery systems. In the downstream link, Headend 105 transmits a signal to node 110. In an example embodiment, headend 105 includes RF to optical converter 145 and optical to RF converter 145 (for downstream transmissions). Node 110 includes optical to RF converter 150 and RF to optical converter 155. Local DOCSIS CMTS 125 receives a stream from internet 115 through data backbone 120. The data signal is combined with video RF 130 in RF combiner 135 and transmitted to headend 105. Headend 105 transmits the signal down the transmission medium to Node 110. Node 110 sends the signal through amplifiers 160 to tap 170 where it is sent to CPE 185 in home 180.

In the upstream direction, CPE 185 sends data to tap 170, which then sends it upstream through amplifiers 160 to be converted by RF to optical converter 155 for transmission over the transmission medium to optical to RF converter 145 in headend 105. The data is then sent to CMTS 125.

In order to maximize the available bandwidth, DOCSIS utilizes TDMA (Time Division Multiple Access) in which any device which wishes to transmits is assigned a slice of time to transmit. During initial connection between the CPE 185 and DOCSIS CMTS 125, a “ranging” function occurs in which the delay caused by the speed of light over the length of the network between the CMTS and the subscriber's home and amplifier latency, is determined. With a 1 usec resolution and taking into account the speed of light and a velocity factor of 75% for coax (range is typically from 66% to 82%), this gives a resolution of about 700 feet per ranging unit (NOTE: Without the velocity factor, the resolution is about 942 feed per ranging unit).

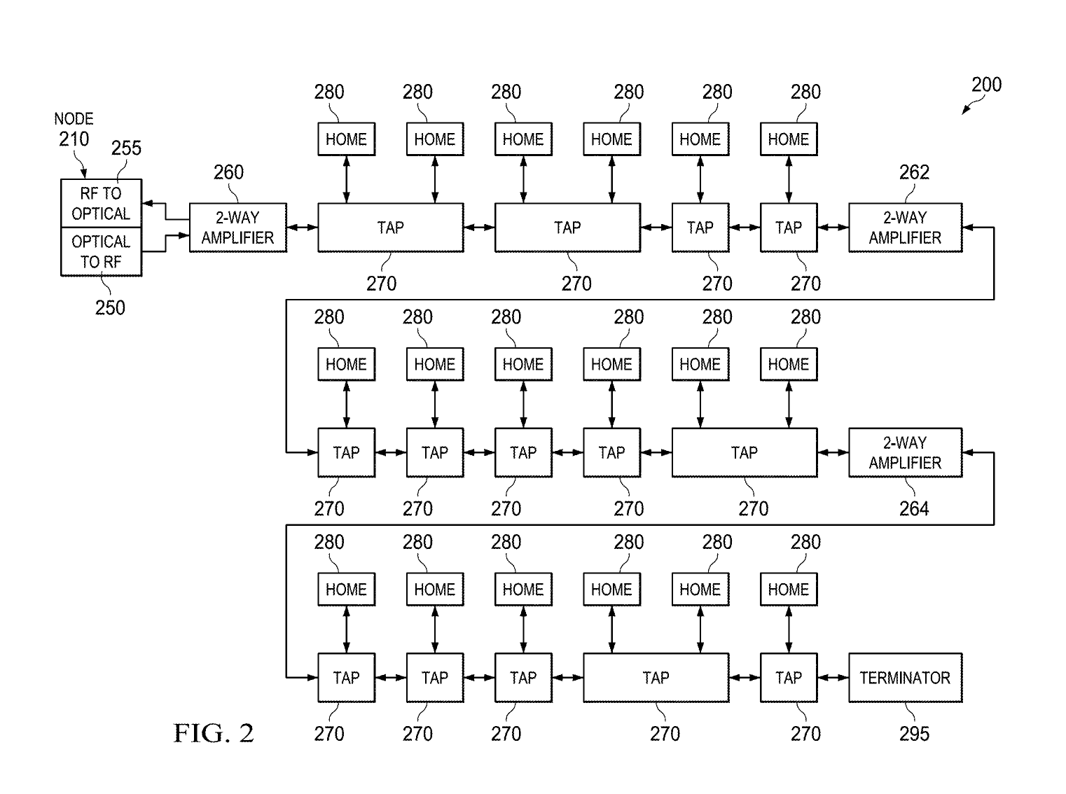

FIG. 2 provides an example embodiment of system 200 of providing data from node 210 to a plurality of homes 280. Node 210 RF to optical converter 255 for upstream interface with the transmission medium and optical to RF converter 250 for downstream interface with the transmission medium. Each home 280 is connected to the system by tap 270. Amplifiers 260, 262, 264 are used to amplify signals. Terminator 295 is used to signify the end of the line of node 210.

A given subscriber's account may comprise a multitude of STBs. There are currently no mechanisms to detect when a subscriber leases an STB with a higher priced viewing package, and then allows someone else with a lower viewing package to utilize that STB, thereby avoiding paying for the higher viewing package.

By determining the ranging values for all STBs assigned to a subscriber and comparing them, it is possible to detect if one or more of the STBs are outside the geographical area of the others. This can indicate to the cable operator that the subscriber and an associate are involved in bypassing the cable operator's agreement.

At the time, there is no mechanism that allows an operator to determine when someone is stealing cable services. For example, someone decides that he can get cable services off of the neighbor's subscription and not have to pay all the extra fees. If the neighbors happen to be connected to different nodes, the misappropriation can be easily discovered. However, if the neighbors are serviced by the same node (which may include 400 or 500 houses), it may be difficult for the operator to discover that someone is stealing the services. Example embodiments of the systems and methods of discovering illegal service appropriation may be employed to discover that someone is stealing or that the STBs are not where they are supposed to be.

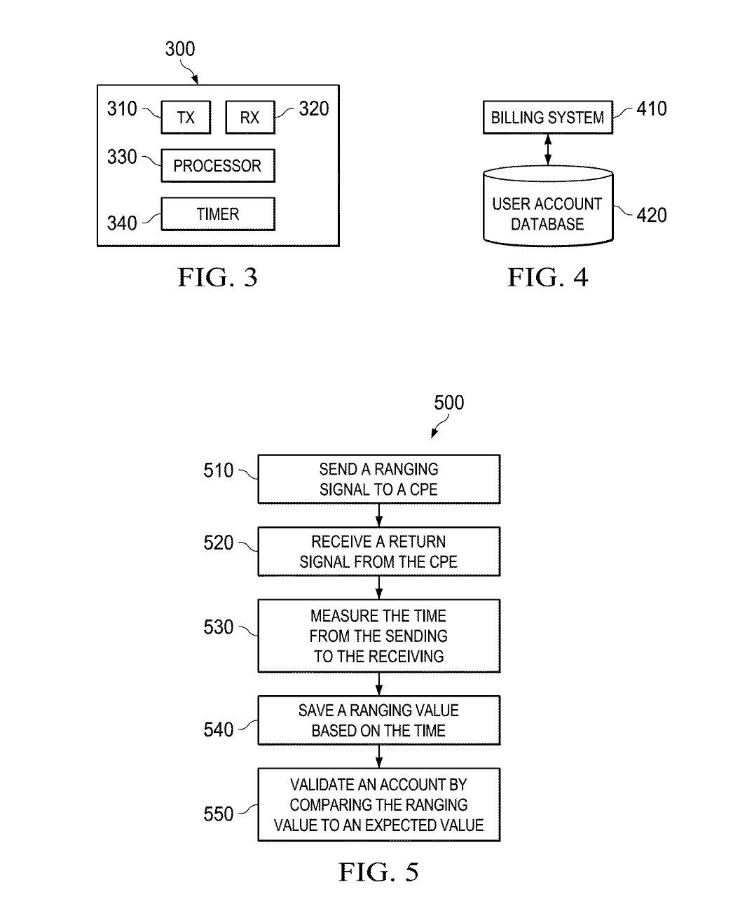

As previously stated, DOCSIS uses Time Division Multiplex Access (TDMA) to transmit data streams to multiple CPEs over a single transmission line. TDMA uses a ranging function to determine when it can transmit for each CPE. The ranging function provides the location of the STB in the system. The distance in time from the CMTS to the STB is a fixed time. This time determines a ranging value. As provided in FIG. 3, CMTS 300 comprises transmitter 310, receiver 320, processor 330 and timer 340, among other functional blocks. To determine the ranging value, a ranging signal is sent from transmitter 310 of CMTS 300 to an STB. The STB, immediately upon receiving the ranging signal, transmits a return signal, which is received by receiver 320 of CMTS 300. CMTS 300 measures this time with timer 340, and processor 330 determines the ranging value. The value is different between CPEs in different homes, primarily affected by the physical distance to the home. The link to the home will include additional amplifiers as provided in FIG. 2, which also add a fixed delay to the ranging value.

In an example, if a subscriber has three STBs in a home, then the ranging value received from them should be substantially identical. If the ranging value one received from one is different by a particular value (for example, several microseconds), then the STB with the different ranging value is a significantly different distant away from the rest of the STBs. This STB may be flagged as a potentially illegal set-top box.

In an example embodiment, timer 340 in CMTS 300 monitors the time between the transmission of the ranging signal and the receiving of the return signal. Processor 330 in CMTS 300 may calculate the ranging value and keep track of it. The ranging value may be determined every few hours as an example; however, any time period or a random period may be set for updating the ranging values. The DOCSIS specification entails diagnostic information that may be captured to build a database for tracking the ranging information.

FIG. 4 provides an example embodiment of billing system 410 in communication with user account database 420. Billing system 410 provides grouping information to define which physical CPEs are within an account as provided by user account database 420. For a valid account, all of the STBs defined by the billing system will be within the home and have ranging values that are very close—within a predetermined value. If any CPE has a ranging value that is greater or smaller than what is expected, then these CPEs may be flagged for investigation.

The CMTS may set the parameters for the TDMA and may use the ranging value to set up TDMA parameters to maximize the return path of the transmission path. The ranging signal and return signal are sent over cable, fiber, and/or other propagation means with known propagation times and known topology. Knowing these factors, the operator can theoretically determine a location of the STB. A CMTS may be employed on the Edge, scattered out as hubs, or at the central office, depending on the layout of the cable system. The positioning of the CMTS will affect the measured delay, but it is a fixed delay and will remain constant.

FIG. 5 provides flow chart 500 of an example embodiment of a method of discovering illegal services appropriation. In block 510 a ranging signal is sent to a CPE. In block 520, a return signal is received from the CPE. In block 530, the time from the sending to the receiving is measured. In block 540, a ranging value is saved based on the time. In block 550, an account is validated by comparing the ranging value to an expected value.

The flow chart of FIG. 5 shows the architecture, functionality, and operation of a possible implementation of the illegal service appropriation discovery software. In this regard, each block represents a module, segment, or portion of code, which comprises one or more executable instructions for implementing the specified logical function(s). It should also be noted that in some alternative implementations, the functions noted in the blocks may occur out of the order noted in FIG. 5. For example, two blocks shown in succession in FIG. 5 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

1. A method comprising:
sending a ranging signal to a plurality of customer premises equipment (CPE) for a subscriber account;
receiving return signals from the plurality of CPE;
measuring the time from the sending to the receiving for each of the return signals;
saving ranging values based on the times; and
validating the subscriber account if the ranging values are within a specified tolerance of each other.

2. The method of claim 1, wherein the ranging signal is sent from a cable modem termination system (CMTS).

3. (canceled)

4. (canceled)

5. The method of claim 1, further comprising accessing a billing system to validate each CPE on an account by comparing the ranging values of each CPE on the account.

6. The method of claim 1, further comprising flagging a CPE that produces a ranging value that is different from an expected value by a predetermined value.

7. A system comprising:
a transmitter configured to transmit a ranging signal to a plurality of customer premises equipment (CPE) for a subscriber account;
a receiver configured to receive return signals from the plurality of CPE;
a timer configured to measure the time between the transmit by the transmitter and the receive by the receiver for each of the return signals; and
a processor configured to save ranging values based on the times and to validate the subscriber account if the ranging values are within a specified tolerance of each other.

8. The system of claim 7, wherein the transmitter and the receiver are housed in a cable modem termination system.

9. (canceled)

10. (canceled)

11. The system of claim 7, wherein the processor is further configured to access a billing system to validate each CPE on an account by comparing the ranging values of each CPE on the account.

12. The system of claim 7, wherein the processor is further configured to flag a CPE that produces a ranging value that is different from an expected value by a predetermined amount.

13. A tangible computer readable medium comprising software, the software comprising instructions for:
sending a ranging signal to a plurality of customer premises equipment (CPE) for a subscriber account;
receiving return signals from the plurality of CPE;
measuring the time from the sending to the receiving for each of the return signals;
saving ranging values based on the times; and
validating the subscriber account if the ranging values are within a specified tolerance of each other.

14. The computer readable medium of claim 13, wherein the instructions for sending ranging signals comprise instructions for sending ranging signals sent from a cable modem termination system (CMTS).

15. (canceled)

16. The computer readable medium of claim 15, further comprising instructions for comparing the ranging value of each of the CPEs of the plurality of CPEs in a premises.

17. The computer readable medium of claim 16, further comprising instructions for accessing a billing system to validate each CPE on an account by comparing the ranging values of each CPE on the account.

18. The computer readable medium of claim 13, further comprising instructions for flagging a CPE that produces a ranging value that is different from the expected value by a predetermined value.

19. The computer readable medium of claim 13, further comprising validating an account by comparing the ranging value to an expected value.
